(19) United States
(12) Patent Application Publication
(10) Pub. No.: US 2017/0293195 A1
(43) Pub. Date: Oct. 12, 2017

(54) ELECTROPHORETIC DISPLAY DEVICE, ELECTRONIC APPARATUS, CONTROL DEVICE, AND DRIVING METHOD

(71) Applicant: SEIKO EPSON CORPORATION, Tokyo (JP)

(72) Inventor: Katsunori YAMAZAKI, Matsumoto-shi (JP)

(73) Assignee: SEIKO EPSON CORPORATION, Tokyo (JP)

(21) Appl. No.: 15/475,591

(22) Filed: Mar. 31, 2017

(30) Foreign Application Priority Data
Apr. 6, 2016 (JP) 2016-076398

(51) Int. Cl. G02F 1/167; G09G 3/34; G02F 1/133

(52) U.S. Cl. CPC G02F 1/167; G02F 1/13306; G09G 3/344; G02F 2001/1672

(57) ABSTRACT

An electrophoretic display device including a first substrate and a second substrate which oppose each other, a first electrode provided on the first substrate, a second electrode provided on the second substrate, a region forming portion for forming a plurality of regions between the first substrate and the second substrate, a dispersion liquid which includes particles and a dispersion medium provided between the first electrode and the second electrode, and a control portion which applies a voltage to the first electrode, in which the first electrode is provided for a pixel, and when the control portion makes an adjacent first pixel and second pixel display the same color, the control portion applies voltages having different waveforms to the first electrode of the first pixel and the first electrode of the second pixel.

### BACKGROUND

### 1. Technical Field

The present invention relates to an electrophoretic display device, an electronic apparatus, a control device, and a driving method.

### 2. Related Art

Electrophoretic display devices (EPD: electrophoretic display) are used, for example, in electronic paper and the like.

In an electrophoretic display device, it is possible to change the contents of the display by separating particles having different colors and reflectance by applying a voltage to a solvent (dispersion medium) into which charged and dispersed particles are injected so as to move the particles to a predetermined electrode side. As an example, in a monochrome display using particles corresponding to white (white particles) and particles corresponding to black (black particles), generally, white is displayed by utilizing the light scattering of the white particles and black is displayed by utilizing the light absorbency of the black particles.

Here, the electrophoretic display device has a structure in which a partition wall or microcapsule is provided between a substrate including a pixel electrode (referred to below as “pixel substrate”) and a substrate including a counter electrode (referred to below as “counter substrate”). A plurality of pixel regions (cells) are formed by the partition walls or the microcapsules. The pixel region is, for example, a pixel unit. In addition, each pixel is filled with a dispersion liquid (electrophoretic material) in which particles are dispersed in a dispersion medium.

Then, an electric field is generated by applying a voltage between the pixel electrode and the counter electrode for each pixel region and, due to this, the charged particles move, thereby changing the color of the display.

In a display portion (for example, a display panel) of such a partition wall-type or capsule-type electrophoretic display device, a pixel electrode and a counter electrode are arranged so as to oppose each other in parallel and a uniform electric field is formed at the inside of the partition wall or the microcapsule (pixel region).

However, with such voltage control, charged particles (for example, white particles or black particles) of the same type present inside the partition wall or the microcapsule all try to move at the same (uniform) speed. Here, in order for the particles to move, it is necessary to exclude the dispersion medium; however, since the charged particles of the same type try to move at the same speed and may enter an antagonistic state, the smooth movement of the particles may be hindered such that the movement of the particles may be delayed, and the changes in the display color may be delayed.

JP-A-2008-268853 is an example of the related art.

As described above, in the control of the voltage in the electrophoretic display device, the movement of particles may be delayed, and the changes in the display color may be delayed.

### SUMMARY

An advantage of some aspects of the invention is to provide an electrophoretic display device, an electronic apparatus, a control device, and a driving method which are able to smoothly change display colors.

According to an aspect of the invention, there is provided an electrophoretic display device including a first substrate and a second substrate which oppose each other, a first electrode provided on the first substrate, a second electrode provided on the second substrate, a region forming portion for forming a plurality of regions between the first substrate and the second substrate, a dispersion liquid which includes particles and a dispersion medium provided between the first electrode and the second electrode, and a control portion which applies a voltage to the first electrode, in which the first electrode is provided for a pixel, and when the control portion makes adjacent first and second pixels display the same color, the control portion applies voltages having different waveforms to the first electrode of the first pixel and the first electrode of the second pixel.

According to this configuration, in the electrophoretic display device, in a case where the same color is displayed in an adjacent first pixel and second pixel, voltages having different waveforms are applied to the first electrode of the first pixel and the first electrode of the second pixel. Due to this, in the electrophoretic display device, it is possible to smoothly change the display color by making the electric field non-uniform.

In addition, the aspect of the invention may use a configuration where, in the electrophoretic display device, when the control portion makes the adjacent first pixel and second pixel display the same color, the control portion applies voltages having a potential difference at a start of display switching to the first electrode of the first pixel and the first electrode of the second pixel.

According to this configuration, in the electrophoretic display device, in a case where an adjacent first pixel and second pixel are made to display the same colors, voltages having a potential difference are applied at a start of display switching to the first electrode of the first pixel and the first electrode of the second pixel. Due to this, in the electrophoretic display device, it is possible to smoothly change the display color by making the electric field non-uniform at the start of display switching.

In addition, the aspect of the invention may use a configuration where, in the electrophoretic display device, when the control portion makes at least one adjacent second pixel display the same color as the first pixel in a plurality of the pixels arranged in a matrix shape, the control portion applies voltages having different waveforms to the first electrode of the first pixel and the first electrode of the second pixel.

According to this configuration, in the electrophoretic display device, in a case where at least one adjacent second pixel is made to display the same color as the first pixel in a plurality of the pixels arranged in a matrix shape, voltages having different waveforms are applied to the first electrode of the first pixel and the first electrode of the second pixel. Due to this, in the electrophoretic display device, it is possible to smoothly change the display colors in a plurality of the pixels arranged in a matrix shape.

In addition, the aspect of the invention may use a configuration where, in the electrophoretic display device, the first pixel is provided with the first electrode of the first pixel, a first storage circuit, and a pair of first switching circuits which conduct or interrupt according to a state of the first storage circuit, one terminal of the pair of first switching circuits is connected in common to the first electrode of the first pixel and another terminal is connected to a first control line and a second control line respectively, the second pixel is provided with the first electrode of the second pixel, a second storage circuit, and a pair of second switching circuits which conduct or interrupt according to a state of the second storage circuit, one terminal of the pair of second switching circuits is connected in common to the first electrode of the second pixel and another terminal is connected to a third control line and a fourth control line respectively.

According to this configuration, in the electrophoretic display device, for the first pixel, the first control line and the second control line are switched, and, for the second pixel, the third control line and the fourth control line are switched. Due to this, in the electrophoretic display device, it is possible to realize a circuit for smoothly changing the display color.

In addition, the aspect of the invention may use a configuration where, in an electrophoretic display device, one of the first control line and the second control line and one of the third control line and the fourth control line are in common.

According to this configuration, in the electrophoretic display device, one control line in the first pixel and one control line in the second pixel are in common. Due to this, it is possible to simplify the circuit in the electrophoretic display device.

According to another aspect of the invention, there is provided an electronic apparatus including the electrophoretic display device as described above.

According to this configuration, in the electrophoretic display device in the electronic apparatus, in a case where the same color is displayed in the adjacent first pixel and the second pixel, voltages having different waveforms are applied to the first electrode of the first pixel and the first electrode of the second pixel. Due to this, in the electrophoretic display device in the electronic apparatus, it is possible to smoothly change the display color by making the electric field non-uniform.

According to still another aspect of the invention, there is provided a control device which controls an electrophoretic display device including a first substrate and a second substrate which oppose each other, a first electrode provided on the first substrate, a second electrode provided on the second substrate, a region forming portion for forming a plurality of regions between the first substrate and the second substrate, and a dispersion liquid which includes particles and a dispersion medium provided between the first electrode and the second electrode, in which, the first electrode is provided in a pixel, when making adjacent first and second pixels display the same color, voltages having different waveforms are applied to the first electrode of the first pixel and the first electrode of the second pixel.

According to this configuration, in the electrophoretic display device in the control device, in a case where the same color is displayed the adjacent first and second pixels, voltages having different waveforms are applied to the first electrode of the first pixel and the first electrode of the second pixel. Due to this, in the electrophoretic display device in the control device, it is possible to smoothly change the display color by making the electric field non-uniform.

According to still another aspect of the invention, there is provided a driving method for driving an electrophoretic display device including a first substrate and a second substrate which oppose each other, a first electrode provided on the first substrate, a second electrode provided on the second substrate, a region forming portion for forming a plurality of regions between the first substrate and the second substrate, and a dispersion liquid which includes particles and a dispersion medium provided between the first electrode and the second electrode, in which, the first electrode is provided for a pixel, when making adjacent first and second pixels display the same color, voltages having different waveforms are applied to the first electrode of the first pixel and the first electrode of the second pixel.

According to this configuration, in the electrophoretic display device in the driving method, in a case where the same color is displayed in the adjacent first pixel and second pixel, voltages having different waveforms are applied to the first electrode of the first pixel and the first electrode of the second pixel. Due to this, in the electrophoretic display device in the driving method, it is possible to smoothly change the display color by making the electric field non-uniform.

As described above, according to the electrophoretic display device, the electronic apparatus, the control device, and the driving method according to the invention, in a case where the same color is displayed in an adjacent first pixel and second pixel in the electrophoretic display device, voltages having different waveforms are applied to the first electrode of the first pixel and the first electrode of the second pixel. Due to this, in the electrophoretic display device, the electronic apparatus, the control device, and the driving method according to the invention, in the electrophoretic display device, it is possible to smoothly change the display colors by making the electric field non-uniform.

### BRIEF DESCRIPTION OF THE DRAWINGS

The invention will be described with reference to the accompanying drawings, wherein like numbers reference like elements.

FIG. 1 is a diagram which shows a schematic configuration example of an electrophoretic display device according to an embodiment (first embodiment) of the invention.

FIG. 2 is a diagram which shows a configuration example of a display portion of the electrophoretic display device according to the embodiment (first embodiment) of the invention.

FIG. 3 is a diagram which shows a configuration example of a pixel circuit according to the embodiment (first embodiment) of the invention.

FIG. 4 is a diagram which shows an example of voltages applied to a pixel electrode and a counter electrode according to the embodiment (first embodiment) of the invention.

FIG. 5 is a diagram which shows an example (first example) of assignment of voltage control of a plurality of pixels according to the embodiment (first embodiment) of the invention.

FIG. 6 is a diagram which shows an example (second example) of assignment of voltage control of the plurality of pixels according to the embodiment (first embodiment) of the invention.

FIG. 7 is a diagram which shows an example (third example) of assignment of voltage control of the plurality of pixels according to the embodiment (first embodiment) of the invention.

FIG. 8 is a diagram which shows an example (fourth example) of assignment of voltage control of the plurality of pixels according to the embodiment (first embodiment) of the invention.

FIG. 9 is a diagram which shows another example of voltages applied to the pixel electrode and the counter electrode according to the embodiment (first embodiment) of the invention.

FIG. 10 is a diagram which shows another configuration example of the pixel circuit according to the embodiment (first embodiment) of the invention.

FIG. 11 is a diagram which shows a schematic configuration example of an electronic apparatus according to an embodiment of the invention (a first example of a second embodiment).

FIG. 12 is a diagram which shows a schematic configuration example of the electronic apparatus according to the embodiment of the invention (a second example of the second embodiment).

FIG. 13 is a diagram which shows a schematic configuration example of the electronic apparatus according to the embodiment of the invention (a third example of the second embodiment).

FIG. 14 is a diagram which shows a configuration example of a pixel circuit according to a comparative technique.

FIG. 15 is a diagram which shows an example of voltages applied to a pixel electrode and a counter electrode according to the comparative technique.

### DESCRIPTION OF EXEMPLARY EMBODIMENTS

Detailed description will be given of embodiments of the invention with reference to the drawings.

### First Embodiment

### Summary of Electrophoretic Display Device

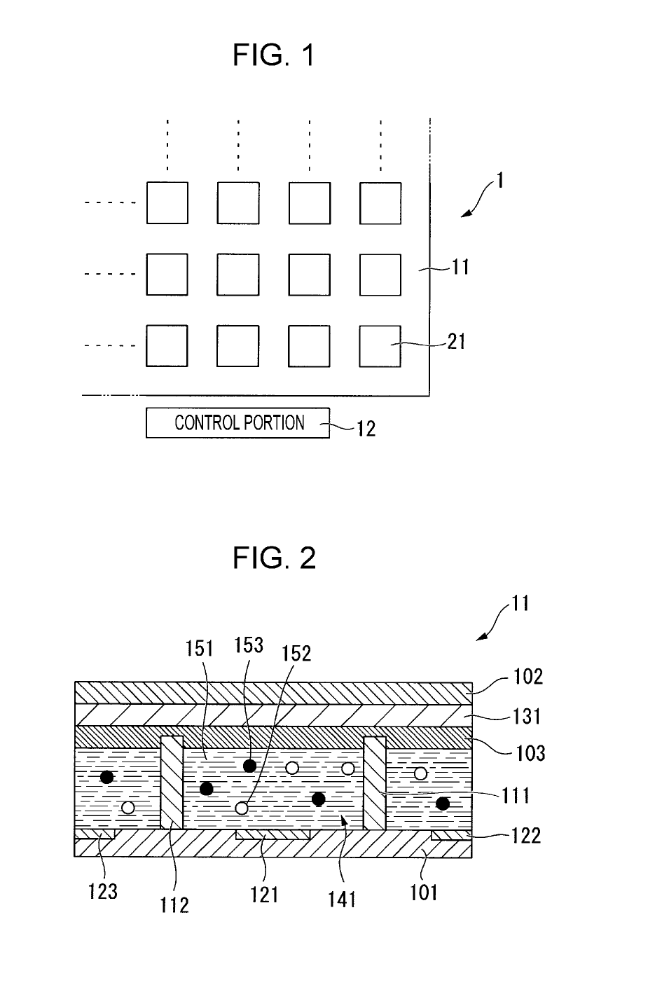

FIG. 1 is a diagram which shows a schematic configuration example of an electrophoretic display device 1 according to one embodiment (first embodiment) of the invention. FIG. 1 is a planar diagram of the electrophoretic display device 1.

The electrophoretic display device 1 is provided with a display portion 11 and a control portion 12.

The display portion 11 is formed of a group of pixels composed of pixels arranged in a vertical direction and a horizontal direction (a matrix shape) and, in the present embodiment, each pixel is partitioned by a partition wall on all sides, and one pixel region 21 is provided for each pixel. Each of the pixel regions 21 is filled with a dispersion liquid which includes white particles and black particles together with a dispersion medium. Controlling the voltage applied to the dispersion liquid for each pixel makes it possible for the control portion 12 to display white using white particles or black using black particles.

Here, the arrangement of the pixel group and the arrangement of the plurality of pixel regions 21 are made to coincide with each other; however, these may be unrelated, and description will be given thereof below.

### Summary of Display Portion

FIG. 2 is a diagram which shows a configuration example of the display portion 11 of the electrophoretic display device 1 according to one embodiment (first embodiment) of the invention. FIG. 2 is a cross-sectional side diagram of the display portion 11, and shows a portion related to a portion of the pixel region 21 not positioned on the outer peripheral side surface.

Here, in the present embodiment, the configurations of two or more pixel regions 21 not facing the outer periphery among the plurality of pixel regions 21 are the same, and the configurations of two or more pixel regions 21 facing the outer periphery are the same. The configuration of the pixel region 21 not facing the outer periphery and the configuration of the pixel region 21 facing the outer periphery are the same except for a different portion depending on whether the configuration faces the outer periphery or not.

The display portion 11 is provided with a first substrate (pixel substrate) 101, a second substrate (counter substrate) 102, a bonding layer 103, partition walls 111 to 112, first electrodes (pixel electrodes) 121 to 123, a second electrode (counter electrode) 131, and a dispersion liquid 141. The dispersion liquid 141 includes a dispersion medium 151, a plurality of a first type of electrophoretic particles (white particles in the present embodiment) 152, and a plurality of a second type of electrophoretic particles (black particles in the present embodiment) 153.

Note that, the “pixel substrate” may be referred to as a “driving substrate” or the like, and the “counter electrode” may be referred to as a “common electrode” or the like.

The pixel substrate 101 and the counter substrate 102 are arranged to oppose each other.

Between the pixel substrate 101 and the counter substrate 102, the partition walls 111 to 112 are provided on the pixel substrate 101. Spaces (cells) of a plurality of partitioned pixel regions 21 are formed by the partition walls 111 to 112.

Between the pixel substrate 101 and the counter substrate 102, pixel electrodes 121 to 123 are provided in the pixel substrate 101 for each pixel region 21.

A counter electrode 131 is provided on the counter substrate 102 between the pixel substrate 101 and the counter substrate 102. In the present embodiment, the counter electrode 131 is a common electrode for the plurality of pixel regions 21; however, as another configuration example, the counter electrode 131 may be provided separately for each of the pixel electrodes 121 to 123. Here, as the counter substrate 102, for example, a glass substrate may be used, and an electrode such as indium tin oxide (ITO), for example, may be used as the counter electrode 131.

Between the pixel substrate 101 and the counter substrate 102, a bonding layer 103 is provided on the counter substrate 102 on the side of the pixel substrate 101 (in the present embodiment, the surface of the counter electrode 131 provided on the counter substrate 102). Here, the bonding layer 103 is in contact with the tip portion (the tip portion on the side of the counter substrate 102) of the partition walls 111 to 112. For example, the bonding layer 103 may have only one layer or may have two or more layers.

In each pixel region 21, a dispersion liquid 141 is provided.

Here, a sealing portion (not shown) is provided on the side surface of the outer periphery of the display portion 11. The sealing portion seals the dispersion liquid 141. Note that the sealing portion may be formed integrally with the partition walls 111 to 112, for example.

In addition, the display portion 11 may include, for example, a transparent adhesive layer (not shown), a light guide (not shown) as a light guide portion, and a light source (not shown) as a light emitting portion.

Specifically, on the counter substrate 102, a transparent adhesive layer is provided on the opposite side to the pixel substrate 101 side. On the transparent adhesive layer, a light guide is provided on the opposite side to the counter substrate 102 side. A light source is provided on a part of the outer periphery of the light guide. Here, the light guide may be, for example, a plate-shaped object (light guide plate). The light guide guides the light emitted from the light source and, due to this, a front light is realized. As the light source, for example, a light emitting diode (LED) may be used.

Although a case where the transparent adhesive layer is provided is shown here, as another configuration example, a configuration may be used where, instead of the transparent adhesive layer, a frame (frame) is provided, the light guide is supported by the frame, and an air layer is provided between the counter substrate 102 and the light guide.

In the present embodiment, the transparent adhesive layer (or frame), the light guide, and the light source may or may not be provided.

In the electrophoretic display device 1, the control portion 12 drives the voltage to control voltages applied to each of the pixel electrodes 121 to 123 and a voltage applied to the counter electrode 131, thereby controlling the colors being displayed in each pixel region 21 (in the present embodiment, white or black). Due to this, the display contents on the display surface are controlled. In the present embodiment, the surface on the side of the counter substrate 102 is a display surface for outputting the display contents.

For example, a voltage is applied between the pixel electrodes 121 to 123 and the counter electrode 131 such that the voltage of the counter electrode 131 is relatively high. Then, since an electric field is generated from the counter electrode 131 toward the pixel electrodes 121 to 123, the positively charged white particles 152 migrate to the side of the pixel electrodes 121 to 123, whereas the negatively charged black particles 153 migrate to the side of the counter electrode 131. As a result, the black particles 153 are gathered on the side of the display surface (the side of the counter electrode 131), and a color (black) corresponding to the black particles 153 is displayed on the display surface.

In contrast, a voltage is applied between the pixel electrodes 121 to 123 and the counter electrode 131 such that the potentials of the pixel electrodes 121 to 123 are relatively high. Then, since an electric field is generated from the pixel electrodes 121 to 123 toward the counter electrode 131, the negatively charged black particles 153 migrate to the side of the pixel electrodes 121 to 123, whereas the positively charged white particles 152 migrate to the side of the counter electrode 131. As a result, the white particles 152 are gathered on the side of the display surface (the side of the counter electrode 131), and the color (white) corresponding to the white particles 152 is displayed on the display surface.

Here, in the present embodiment, the partition walls 111 to 112 are provided on the side of pixel substrate 101 and the bonding layer 103 is provided on the side of the counter substrate 102; however, as another configuration example, a configuration may be used in which the bonding layer 103 is provided on the side of the pixel substrate 101 and the partition walls 111 to 112 are provided on the side of the counter substrate 102.

In addition, in the present embodiment, the white particles 152 and the black particles 153 are used; however, as another configuration example, particles corresponding to other colors may be used.

In addition, in the present embodiment, two types of particles corresponding to two colors (black and white) are used as the particles included in the dispersion liquid 141; however, as another configuration example, one type of particles corresponding to one color may be used, or three or more types of particles corresponding to three or more colors may be used.

For example, using pigments such as red, green, and blue makes it also possible to obtain the electrophoretic display device 1 provided with a display portion 11 which displays red, green, blue, and the like.

In addition, in the present embodiment, as a shape in which spaces (closed spaces forming cells) for each of the pixel regions 21 formed by the partition walls 111 to 112 are lined up, a square shape (for example, a shape in which rectangular bodies are lined up) may be used; however, as other configuration examples, other shapes may be used such as a honeycomb shape (a shape in which regular hexagonal prisms are lined up).

Here, there may be a plurality of pixel electrodes in one closed space and, in addition, a partition wall may be present on the pixel electrode.

In addition, In the present embodiment, a partition wall type in which the pixel region 21 is formed by the partition walls 111 to 112 is used; however, as another configuration example, a capsule type in which the pixel region 21 is formed with microcapsules which accommodate the dispersion liquid may be used. In such a case, a plurality of closed spaces may exist for one pixel electrode. In this manner, it is not necessarily necessary to have an association between the arrangement of the pixels (electrodes) and the arrangement of the closed spaces. Here, the partition walls 111 to 112 or microcapsules are examples of a region forming portion.

### Configuration Example of Pixel Circuit

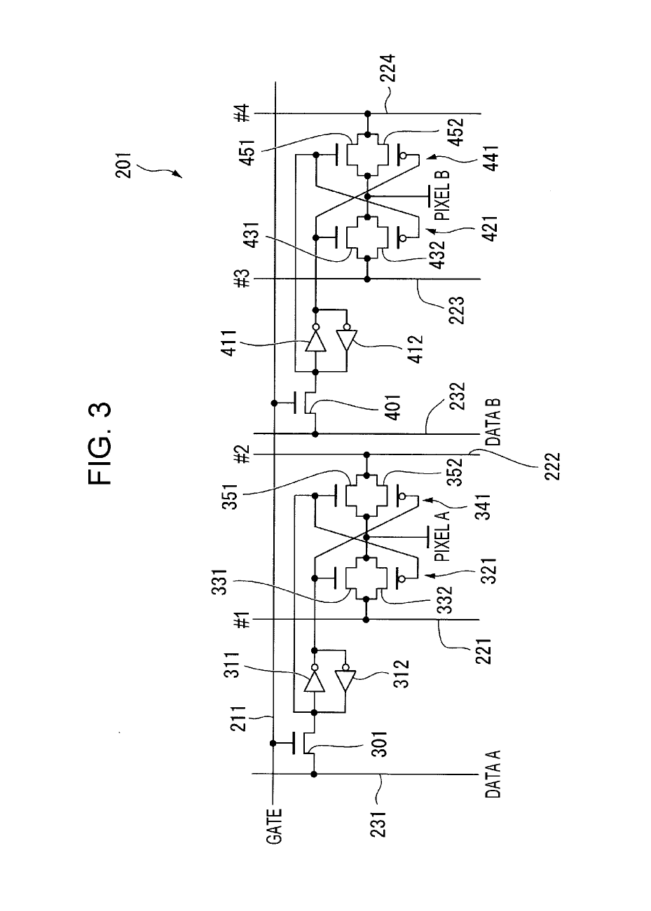

FIG. 3 is a diagram which shows a configuration example of a pixel circuit 201 according to one embodiment (the first embodiment) of the invention.

FIG. 3 shows a circuit related to a first pixel (also referred to below as “pixel A”), a circuit related to a second pixel (also referred to below as “pixel B”), and a circuit common to these circuits as the pixel circuit 201. Pixel A and pixel B are adjacent to each other.

Here, in the present embodiment, a case where one pixel is provided in one pixel region 21 is shown; however, as another configuration example, a configuration in which two or more pixels are provided in one pixel region 21 may be used. For example, in the present embodiment, the pixel region 21 is formed for each of the pixels A and B; however, as another configuration example, the pixel region 21 may be formed for every predetermined number of two or more pixels.

A scanning line 211 through which a signal (scanning signal) for scanning a plurality of pixels is transmitted is provided as a circuit common to the pixels A and B.

As the circuit relating to pixel A, a control line (first control line) 221, a control line (second control line) 222, a data line 231, a selection switch thin film transistor (TFT) 301, an inverter 311, an inverter 312, a transfer gate 321, and a transfer gate 341 are provided. The transfer gate 321 is provided with a negative metal oxide semiconductor (N-MOS) 331 and a positive metal oxide semiconductor (P-MOS) 332. The transfer gate 341 includes an N-MOS 351 and a P-MOS 352. The circuit portion of the two inverters 311 to 312 is used as a memory (storage circuit).

As the circuit relating to the pixel B, a control line (third control line) 223, a control line (fourth control line) 224, a data line 232, a selection switch TFT 401, an inverter 411, an inverter 412, a transfer gate 421, and a transfer gate 441 are provided. The transfer gate 421 is provided with an N-MOS 431 and a P-MOS 432. The transfer gate 441 is provided with an N-MOS 451 and a P-MOS 452. The circuit portion of the two inverters 411 to 412 is used as a memory (storage circuit).

Note that, the first control line 221 and the third control line 223 correspond to each other, and the second control line 222 and the fourth control line 224 correspond to each other. In the present embodiment, for example, a power supply line is used as each of the control lines 221 to 224.

Here, in the present embodiment, the circuit related to the pixel A and the circuit related to the pixel B carry out the same operation with the same configuration with the exceptions that the voltage applied to the control lines 221 and 222 in the circuit related to the pixel A and the voltage applied to the control lines 223 and 224 in the circuit related to the pixel B are different, data (also referred to below as “data A”) relating to the pixel A is input by the data line 231 in the circuit relating to the pixel A and data (also referred to below as “data B”) relating to the pixel B is input by the data line 232 in the circuit relating to the pixel B, and the pixel electrode (in the present embodiment, the pixel electrode 121 shown in FIG. 2) in the circuit relating to pixel A and the pixel electrode (in the present embodiment, the pixel electrode 122 shown in FIG. 2) in the circuit relating to pixel B are different.

Description will be given of the circuit related to the pixel A as an example.

A scanning line 211 is connected to the gate of the TFT 301, a data line 231 is connected to the other end (source) of the TFT 301, and the input terminal of the inverter 311, the output terminal of the inverter 312, the gate of the N-MOS 351, and the gate of the P-MOS 332 are connected to the other end (drain) of the TFT 301.

In addition, the output terminal of the inverter 311, the input terminal of the inverter 312, the gate of the N-MOS 331, and the gate of the P-MOS 352 are connected.

In addition, the other end (source) of the N-MOS 331 and the other end (source) of the P-MOS 332 are connected to the first control line 221. In addition, the other end (source) of the N-MOS 351 and the other end (source) of the P-MOS 352 are connected to the second control line 222.

In addition, the remaining end (drain) of the N-MOS 331, the remaining end (drain) of the P-MOS 332, the remaining end (drain) of the N-MOS 351 and the remaining end (drain) of the P-MOS 352 and the pixel electrode of the pixel A (in the present embodiment, the pixel electrode 121 shown in FIG. 2) are connected.

In the circuit related to the pixel A, the data A input to the data line 231 is one value of binary values (for example, low level and high level). The TFT 301 stores the potential of the data A when a high level is applied to the gate. Then, in a case where the value of the data A is one of binary values (low level in the present embodiment), a voltage #1 applied to the first control line 221 is applied to the pixel electrode of the pixel A. On the other hand, in a case where the value of the data A is the other of the binary values (high level in the present embodiment), a voltage #2 applied to the second control line 222 is applied to the pixel electrode of the pixel A.

In the same manner, in the circuit related to the pixel B, the data B input to the data line 232 is one of binary values (for example, low level and high level). In a case where the value of the data B is one of binary values (low level in the present embodiment), a voltage #3 applied to the third control line 223 is applied to the pixel electrode (in the present embodiment, the pixel electrode 122 shown in FIG. 2) of the pixel B. On the other hand, in a case where the value of the data B is the other of the binary values (high level in the present embodiment), a voltage #4 applied to the fourth control line 224 is applied to the pixel electrode of the pixel B.

Here, for example, a predetermined voltage [volts] higher than 0 [volts] is used as the high level (H) of the data A and B, and 0 [volts] is used as the low level (L) of the data A and B. In the present embodiment, the lowest potential among the potentials applied to the counter electrode 131 is set as the reference potential, and the reference potential is set to the low level.

In the present embodiment, the control portion 12 controls the pixel A to display black by setting the data A to a low level in the circuit related to the pixel A, and controls the pixel A to display white by setting the data A to a high level.

In the same manner, in the circuit related to the pixel B, the control portion 12 controls the pixel B to display black by setting the data B to the low level, and controls the pixel B to display white by setting the data B to the high level.

### Example of Voltages Applied to Pixel Electrode and Counter Electrode

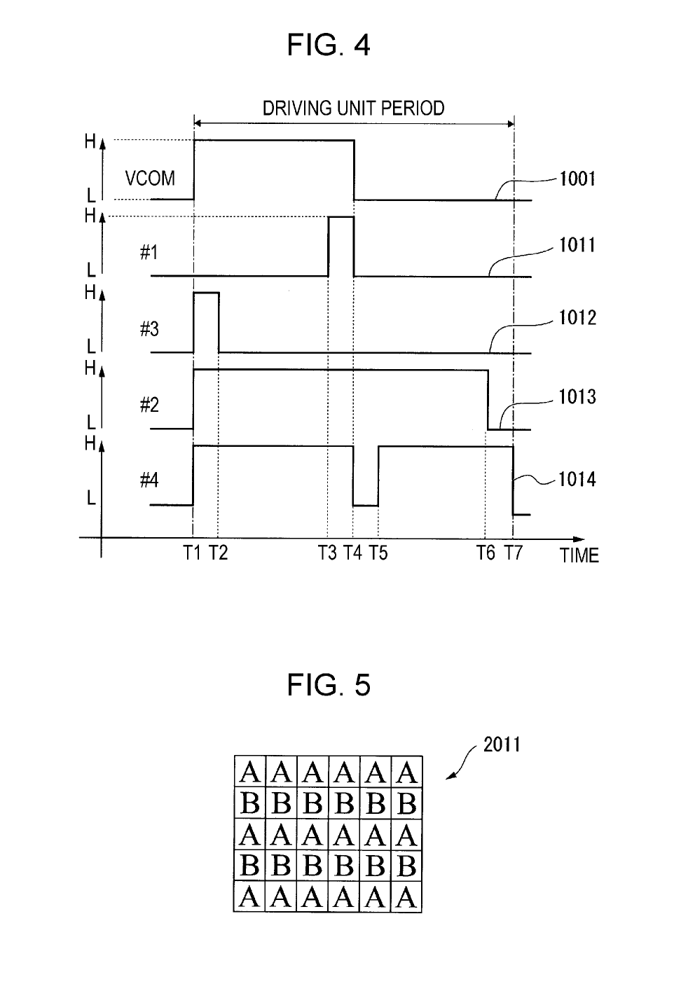

FIG. 4 is a diagram which shows an example of voltages applied to the pixel electrode (here, the pixel electrodes 121 to 122) and the counter electrode 131 according to one embodiment (the first embodiment) of the invention.

FIG. 4 shows an example of voltage waveform changes over time for a voltage 1001 applied to the counter electrode 131 (VCOM) common to the two pixels A and B, a voltage 1011 (=voltage #1) applied to the pixel electrode 121 of the pixel A at the time of black display, a voltage 1012 (=voltage #3) applied to the pixel electrode 122 of the pixel B at the time of black display, a voltage 1013 (=voltage #2) applied to the pixel electrode 121 of the pixel A at the time of white display, and a voltage 1014 (=voltage #4) applied to the pixel electrode 122 of the pixel B at the time of white display.

In the graph shown in FIG. 4, the horizontal axis represents time and the vertical axis represents the voltage magnitude (high and low) for each voltage 1001, and 1011 to 1014.

Here, in the example of FIG. 4, time T1 to time T7 represent times proceeding in order. The time T7 is a later time than the time T1.

In addition, in the present embodiment, as a theoretical value, each of the voltages 1001, and 1011 to 1014 is switched between either value of a high-level voltage (for example, a predetermined voltage (H) [volts] higher than 0) and a low-level voltage (L) (for example, 0 [volts]). Note that, the actual voltage waveform may have some distortion or the like.

In the present embodiment, the period from the time T1 to the time T7 is a unit period (driving unit period) in which driving for controlling display of each pixel A, B is performed. The control portion 12 controls display of each pixel A, B for each driving unit period. Voltage control for each driving unit period may be performed, for example, during only one driving unit period or repeatedly over a plurality of driving unit periods.

In the present embodiment, the period from the time T1 to the time T4 and the period from the time T4 to the time T7 are the same length.

In the present embodiment, the period from the time T1 to the time T2, the period from the time T3 to the time T4, the period from the time T4 to the time T5, and the period from the time T6 to the time T7 are each the same length (here, referred to as the length L1). Due to this, the period from the time T2 to the time T3 and the period from the time T5 to the time T6 are the same length (here, referred to as the length L2). In addition, in the present embodiment, the length L2 is longer than the length L1.

The voltage 1001 applied to the counter electrode 131 is high level from the time T1 to the time T4 and low level from the time T4 to the time T7.

The voltage 1011 applied to the pixel electrode 121 of the pixel A at the time of black display is low level from the time T1 to the time T3, high level from the time T3 to the time T4, and low level from the time T4 to the time T7.

The voltage 1012 applied to the pixel electrode 122 of the pixel B at the time of black display is high level from the time T1 to the time T2 and is low level from the time T2 to the time T7.

The voltage 1013 applied to the pixel electrode 121 of the pixel A at the time of white display is high level from the time T1 to the time T6 and low level from the time T6 to the time T7.

The voltage 1014 applied to the pixel electrode 122 of the pixel B at the time of white display is high level from the time T1 to the time T4, is low level from the time T4 to the time T5, and is high level from the time T5 to the time T7.

Here, description will be given of when the state of the memory of two adjacent pixels A and B (states of data A and B) are both low level.

At this time, both of the two pixels A and B display black, the voltage 1011 is conducted through the control line 221 and applied to the pixel electrode 121 of the pixel A, and the voltage 1012 is conducted through the control line 223 and applied to the pixel electrode 122 of the pixel B. In such a case, from the time T1 to the time T2, with the voltage of the counter electrode 131 as a reference voltage, the voltage of the pixel electrode 121 of the pixel A becomes a negative voltage and the voltage of the pixel electrode 122 of the pixel B becomes equal to the reference voltage. Then, the potential difference between the pixel electrode 122 and the counter electrode 131 of the pixel B is 0, whereas the potential difference between the pixel electrode 121 and the counter electrode 131 of the pixel A is not 0 and, due to this, the electric field becomes non-uniform, the antagonism in the movement of the particles (in the present embodiment, the white particles 152 and the black particles 153) is destroyed, and the particles are rapidly moved, for example, the change from the white display to the black display becomes faster.

Here, in such a case, for the pixel A, the movement of particles for black display occurs from the time T1 to the time T3, and, for the pixel B, the movement of particles for black display occurs from the time T2 to the time T4.

In addition, description will be given of when the states (states of the data A and B) of the memories of two adjacent pixels A and B are both high level.

At this time, both of the two pixels A and B display white, the voltage 1013 is conducted through the control line 222 and applied to the pixel electrode 121 of the pixel A, and the voltage 1014 is conducted through the control line 224 and applied to the pixel electrode 122 of the pixel B. In such a case, from the time T4 to the time T5, with the voltage of the counter electrode 131 as the reference voltage, the voltage of the pixel electrode 121 of the pixel A becomes a positive voltage and the voltage of the pixel electrode 122 of the pixel B becomes equal to the reference voltage. Then, the potential difference between the pixel electrode 122 and the counter electrode 131 of the pixel B is 0, whereas the potential difference between the pixel electrode 121 and the counter electrode 131 of the pixel A is not 0 and, due to this, the electric field becomes non-uniform, the antagonism in the movement of the particles (in the present embodiment, the white particles 152 and the black particles 153) is destroyed, and the particles are rapidly moved, for example, the change from the black display to the white display becomes faster.

Here, in such a case, for pixel A, movement of particles for white display occurs from the time T4 to the time T6, and, for pixel B, the movement of particles for white display occurs from the time T5 to the time T7.

In addition, description will be given of when the state of the memory of one pixel A (the state of data A) is low level and the state of memory of the other pixel B (the state of data B) is high level.

At this time, the pixel A displays black and the pixel B displays white. The voltage 1011 is applied to the pixel electrode 121 of the pixel A, and the voltage 1014 is applied to the pixel electrode 122 of the pixel B.

In such a case, from the time T1 to the time T3, as the reference voltage with the voltage of the counter electrode 131, the voltage of the pixel electrode 121 of the pixel A becomes the negative voltage and the voltage of the pixel electrode 122 of the pixel B becomes equal to the reference voltage. Then, the potential difference between the pixel electrode 122 and the counter electrode 131 of the pixel B is 0, whereas the potential difference between the pixel electrode 121 and the counter electrode 131 of the pixel A is not 0 and, due to this, the electric field becomes non-uniform, the antagonism in the movement of the particles (in the present embodiment, the white particles 152 and the black particles 153) is destroyed, and the particles are rapidly moved, for example, the change from the white display to the black display becomes faster for pixel A.

In addition, in such a case, from the time T5 to the time T7, with the voltage of the counter electrode 131 as the reference voltage, the voltage of the pixel electrode 121 of the pixel A becomes equal to the reference voltage and the voltage of the pixel electrode 122 of the pixel B becomes a positive voltage. Then, the potential difference between the pixel electrode 121 and the counter electrode 131 of the pixel A is 0, whereas the potential difference between the pixel electrode 122 and the counter electrode 131 of the pixel B is not 0 and, due to this, the electric field becomes non-uniform, the antagonism in the movement of the particles (in the present embodiment, the white particles 152 and the black particles 153) is destroyed, and the particles are rapidly moved, for example, the change from the black display to the white display becomes faster for pixel B.

Here, in this case, for pixel A, the movement of particles for black display occurs from the time T1 to the time T3 and, for pixel B, the movement of particles for white display occurs from the time T5 to the time T7.

In addition, description will be given of when the state of the memory of one pixel A (the state of the data A) is high level and the state of the memory of the other pixel B (the state of the data B) is low level.

At this time, pixel A displays white and pixel B displays black. The voltage 1013 is applied to the pixel electrode 121 of the pixel A and the voltage 1012 is applied to the pixel electrode 122 of the pixel B.

In this case, from the time T2 to the time T4, with the voltage of the counter electrode 131 as the reference voltage, the voltage of the pixel electrode 121 of the pixel A becomes equal to the reference voltage and the voltage of the pixel electrode 122 of the pixel B becomes a negative voltage. Then, the potential difference between the pixel electrode 121 and the counter electrode 131 of the pixel A is 0, whereas the potential difference between the pixel electrode 122 and the counter electrode 131 of the pixel B is not 0 and, due to this, the electric field becomes non-uniform, the antagonism in the movement of the particles (in the present embodiment, the white particles 152 and the black particles 153) is destroyed, and the particles are rapidly moved, for example, the change from the white display to the black display becomes faster for pixel B.

In addition, in this case, from the time T4 to the time T6, with the voltage of the counter electrode 131 as the reference voltage, the voltage of the pixel electrode 121 of the pixel A becomes the positive voltage and the voltage of the pixel electrode 122 of the pixel B becomes equal to the reference voltage. Then, the potential difference between the pixel electrode 121 of the pixel B and the counter electrode 131 is 0, whereas the potential difference between the pixel electrode 122 and the counter electrode 131 of the pixel A is not 0 and, due to this, the electric field becomes non-uniform, the antagonism in the movement of the particles (in the present embodiment, the white particles 152 and the black particles 153) is destroyed, and the particles are rapidly moved, for example, the change from the black display to the white display becomes faster for pixel A.

Here, in such a case, for pixel A, the movement of particles for white display occurs from the time T4 to the time T6, and, for pixel B, the movement of particles for black display occurs from the time T2 to the time T4.

Here, in the example of FIG. 4, at the time of black display, the reason why the voltage 1011 applied to the pixel electrode 121 of the pixel A just before the end of the high-level period of the counter electrode 131 (the period from the time T3 to the time T4) is the high level is because, in relation to the black display, the time for which the high-level voltage is applied is set to be the same between the adjacent pixel A and pixel B (the voltage 1012) and, due to this, for example, it is possible to suppress (or prevent) display unevenness between the adjacent pixels A and B.

As another configuration example, a configuration may be used in which the voltage 1011 is always kept at the low level during the driving unit period.

In addition, in the example of FIG. 4, at the time of white display, the reason why the voltage 1013 applied to the pixel electrode 121 of the pixel A just before the end of the low-level period of the counter electrode 131 (the period from the time T6 to the time T7) is the low level is because, at the time of the white display, the time for which the high-level voltage is applied is the same as for the adjacent pixel B (the voltage 1014) and, due to this, for example, it is possible to suppress (or prevent) display unevenness between the adjacent pixels A and B.

As another configuration example, a configuration may be used in which the voltage 1013 is always kept at the high level during the driving unit period.

In addition, in the example of FIG. 4, at the time of the black display, the reason why the voltage 1012 applied to the pixel electrode 122 of the pixel B at the start of the high-level period of the counter electrode 131 (the period from the time T1 to the time T2) is the high level is in order to smooth the movement of the particles at the initial timing, in relation to the black display.

As another configuration example, at the time of black display, the voltage 1012 applied to the pixel electrode 122 of the pixel B may be set to the high level at the timing after the initial period of the high-level period of the counter electrode 131. Note that, normally, it is considered that the timing is set to a timing earlier than the end of the high-level period of the counter electrode 131.

In addition, in the example of FIG. 4, at the time of the white display, the reason why the voltage 1014 applied to the pixel electrode 122 of the pixel B at the start of the low-level period of the counter electrode 131 (the period from the time T4 to the time T5) is the low level is in order to smooth the movement of the particles at the initial timing, in relation to the white display.

As another configuration example, at the time of white display, the voltage 1014 applied to the pixel electrode 122 of the pixel B may be set to the low level at the timing after the initial period of the low-level period of the counter electrode 131. Note that, normally, it is considered that the timing is set to a timing earlier than the end of the low-level period of the counter electrode 131.

Here, in the example of FIG. 4, for pixel A, the voltage 1011 (voltage #1) was used for the black display, the voltage 1013 (voltage #2) was used for the white display, and, in addition, for pixel B, the voltage 1012 (voltage #3) was used for the black display and the voltage 1014 (voltage #4) was used for the white display.

As another configuration example, the control portion 12 may carry out switching so as to synchronize the first combination of the two voltages (voltage #1 and voltage #2) and the second combination of the two voltages (voltage #3 and voltage #4) in the pixels A and B with each other to use different combinations in each of the pixels A and B. That is, when using the first combination for the pixel A, the control portion 12 carries out control so as to use the second combination for the pixel B, and when using the second combination for the pixel A, carries out control so as to use the first combination for the pixel B. In this case, switching between the first combination and the second combination may be performed, for example, by switching control lines to which the respective voltages are applied, or by switching the voltages applied to the respective control lines instead of switching the control lines.

In addition, the control portion 12 may control the display (color control) in an optional manner for the pixel A and the pixel B, respectively.

For example, the control portion 12 may control the driving voltage such that the pixels A and B display the same color.

For example, the control portion 12 may control the driving voltage such that the pixels A and B display different colors.

For example, the control portion 12 may control the driving voltage such that the pixel A and the pixel B change from a state of displaying the same color to a state of displaying other colors.

For example, the control portion 12 may perform control so as to display white or black for one of the pixels A and B and display an intermediate color (for example, gray) for the other.

For example, the control portion 12 may carry out control such that a state of displaying white or black is changed to a state of displaying other colors in one of the pixel A and pixel B, and may carry out control such that a state of displaying an intermediate color (for example, gray) is changed to a state of displaying another color for the other.

Here, in the display portion 11, for example, even when the pixel regions 21 of the two pixels A and B are partitioned by the partition walls (the partition walls 111 in the example of FIG. 2), since the electric field has an influence through the partition walls, the voltage control of the present embodiment is effective.

### Example of Voltage Control of Multiple Pixels

In the description above, description was given of a case of performing voltage control for two adjacent pixels A and B with reference to FIG. 3 and FIG. 4.

Here, normally, the display portion 11 has a large number of pixels (a large number of pixel regions 21). In the present embodiment, either one of the voltage control of the pixel A (or voltage control similar thereto) or the voltage control of the pixel B (or voltage control similar thereto) is assigned to each of a large number of pixels of the display portion 11, and the voltage of each pixel is controlled by the control portion 12.

With reference to FIG. 5 to FIG. 8, examples of the assignment of voltage control of a plurality of pixels are shown.

In the examples of FIG. 5 to FIG. 8, a plurality of pixels of the display portion 11 are shown in a vertical and horizontal matrix shape. Then, for each pixel, the voltage control assigned among the voltage control of the pixel A and the voltage control of the pixel B described with reference to FIG. 4 is shown. In the example of FIG. 5, the voltage control of the pixel A is performed with respect to the pixels in which the character “A” is indicated, and the voltage control of the pixel B is performed with respect to the pixels in which the character “B” is indicated.

FIG. 5 is a diagram which shows an example (first example) of voltage control assignment 2011 for a plurality of pixels according to an embodiment (first embodiment) of the invention.

In the example of FIG. 5, the row in which the voltage control of the pixel A is performed for all of the plurality of pixels lined up in the horizontal direction and the row in which the voltage control of the pixel B is performed for all of the plurality of pixels lined up in the horizontal direction are alternately lined up in the vertical direction. Then, two adjacent pixels in the vertical direction have the relationship between the pixel A and the pixel B (or a relationship similar thereto).

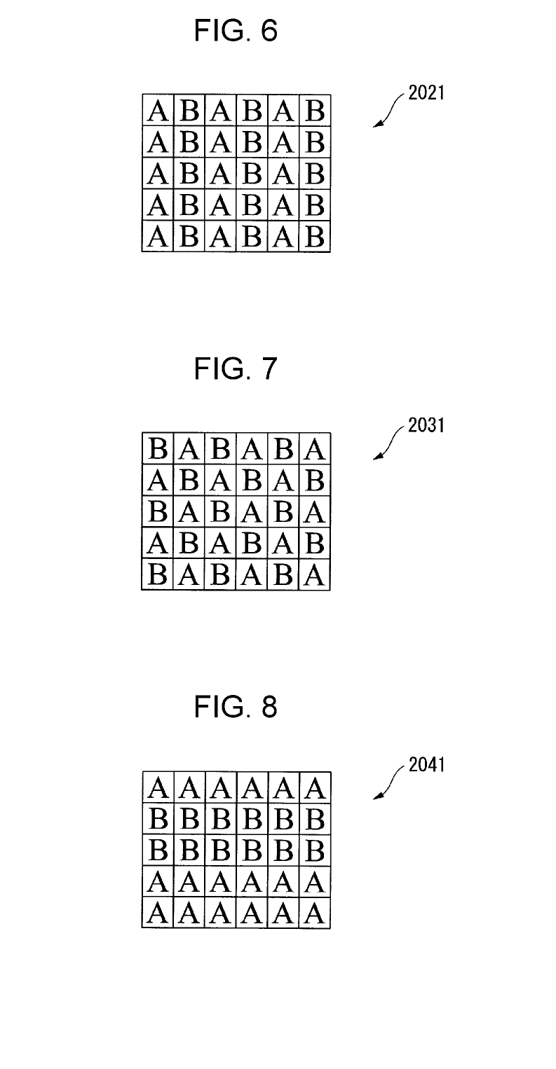

FIG. 6 is a diagram which shows an example (second example) of voltage control assignment 2021 of a plurality of pixels according to an embodiment (first embodiment) of the invention.

In the example of FIG. 6, a column in which voltage control of pixel A is performed for all of a plurality of pixels lined up in the vertical direction and a column in which voltage control of pixel B is performed for all of a plurality of pixels lined up in the vertical direction are alternately lined up in the horizontal direction. Then, two pixels adjacent to each other in the horizontal direction have a relationship between the pixel A and the pixel B (a relationship similar thereto).

FIG. 7 is a diagram which shows an example (third example) of voltage control assignment 2031 of a plurality of pixels according to an embodiment (first embodiment) of the invention.

In the example of FIG. 7, arrangement is made such that the voltage control of the pixel A and the voltage control of the pixel B are alternately assigned to a plurality of pixels lined up in the vertical direction, and the voltage control of the pixel A and the voltage control of the pixel B are alternately assigned to a plurality of pixels lined up the horizontal direction. Then, two pixels adjacent in the horizontal direction have the relationship (or a similar relationship thereto) between the pixel A and the pixel B, and two pixels adjacent in the vertical direction have the relationship (or a similar relationship thereto) between the pixel A and the pixel B.

FIG. 8 is a diagram which shows an example (fourth example) of the voltage control assignment 2041 of a plurality of pixels according to an embodiment (first embodiment) of the invention.

In the example of FIG. 8, one row in which the voltage control of the pixel A is performed for all of a plurality of pixels lined up in the horizontal direction and one row in which the voltage control of the pixel B is performed for all of a plurality of pixels lined up in the horizontal direction are lined up in the vertical direction. Subsequently, one row, in which the voltage control of the pixel B is performed for all of the plurality of pixels lined up in the horizontal direction, and one row, in which the voltage control of the pixel A is performed for all of the plurality of pixels lined up in the horizontal direction, are lined up in the vertical direction. Further, four rows to which the same voltage control as these four rows is assigned are repeatedly arranged. Then, two pixels adjacent to each other in the vertical direction (upward direction or downward direction) have the relationship (or a relationship similar thereto) between the pixel A and the pixel B.

### Another Example of Voltage Applied to Pixel Electrode and Counter Electrode

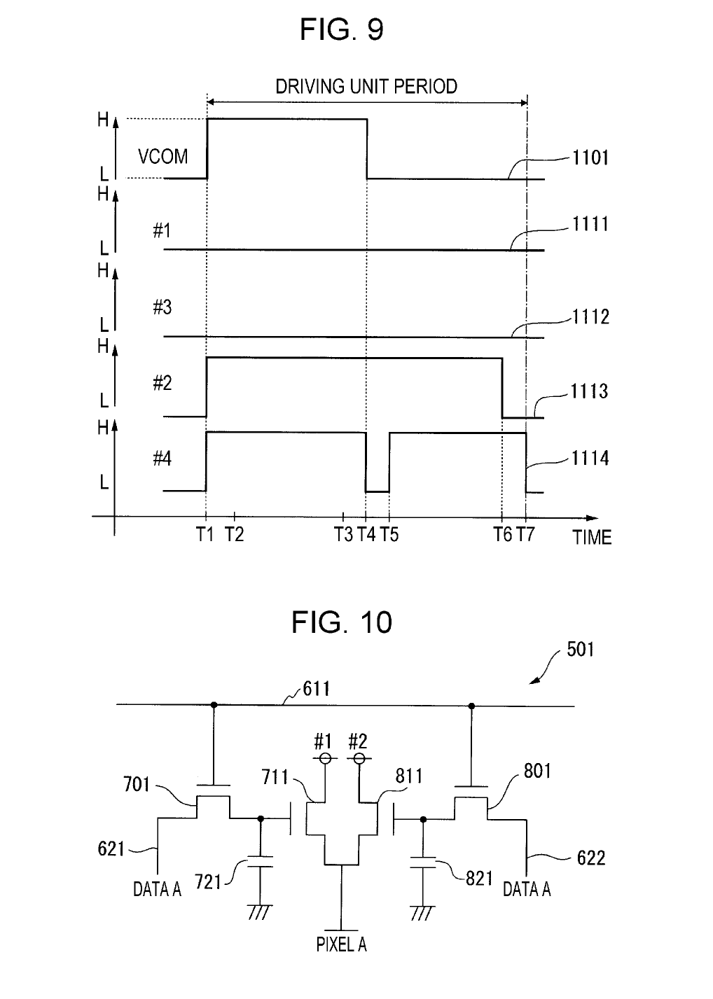

FIG. 9 is a diagram which shows another example of the voltage applied to the pixel electrodes (here, the pixel electrodes 121 to 122) and the counter electrode 131 according to one embodiment (the first embodiment) of the invention.

FIG. 9 shows an example of voltage waveform changes over time for the voltage 1101 applied to the counter electrode 131 (VCOM) common to the two pixels A and B, the voltage 1111 (=voltage #1) applied to the pixel electrode 121 of the pixel A at the time of black display, the voltage 1112 (=voltage #3) applied to the pixel electrode 122 of the pixel B at the time of black display, the voltage 1113 (=voltage #2) applied to the pixel electrode 121 of the pixel A at the time of white display, and the voltage 1114 (=voltage #4) applied to the pixel electrode 122 of the pixel B at the time of white display.

In the graph shown in FIG. 9, the horizontal axis represents time and the vertical axis represents the voltage magnitude (high and low) for each voltage 1101, and 1111 to 1114.

In addition, in the example of FIG. 9, the times T1 to T7 and the driving unit period are the same as in the example of FIG. 4.

In the example of FIG. 9, the voltage 1101 applied to the counter electrode 131, the voltage 1113 applied to the pixel electrode 121 of the pixel A at the time of white display, and the voltage 1114 applied to the pixel electrode 122 of the pixel B at the time of white display each have the same waveform as the corresponding voltage (the voltage 1001, the voltage 1013, and the voltage 1014) in the example of FIG. 4.

In addition, in the example of FIG. 9, both the voltage 1111 applied to the pixel electrode 121 of the pixel A at the time of black display and the voltage 1112 applied to the pixel electrode 122 of the pixel B at the time of black display are always low level during the driving unit period.

In the voltage control in the example of FIG. 9, smooth particle movement is achieved for the white display, while smooth particle movement is not achieved for the black display.

For this reason, for example, in the state in which the voltage control in the example of FIG. 4 is not applied in the display portion 11, in a case of having electrophoretic characteristics in which the change from black display to white display is slower than the change from white display to black display, applying the voltage control in the example of FIG. 9 makes it possible to accelerate the change from the black display to the white display. Due to this, it is possible to adjust the speed of change from white display to black display and the speed of change from black display to white display so as to be closer (for example, equalized).

In addition, in the example of FIG. 9, it is possible to make the control line of the voltage 1111 of the pixel A for performing black display and the control line of the voltage 1112 of the pixel B for performing black display in common and to simplify the layout of the pixel circuit.

Here, in contrast to the example of FIG. 9, it is possible to use the voltage 1011 of the pixel A for performing the black display and the voltage 1012 of the pixel B for performing the black display in the example of FIG. 4, while setting the voltage of the pixel A for performing white display and the voltage of the pixel B for performing white display to both always be the high level in the driving unit period. In this case, smooth particle movement is achieved for the black display, while smooth particle movement is not achieved for the white display. Due to this, it is possible to obtain the same effect as the example of FIG. 9 (an effect of switching between black and white).

In this manner, for example, in a case where the speed of change from white display to black display and the speed of change from black display to white display are different in the display portion 11, it is possible to carry out adjustments such that the speed of changes for both is made closer (for example, equalized). Due to this, for example, it is possible to improve the appearance at the time of display updates.

### Another Configuration Example of Pixel Circuit

FIG. 10 is a diagram which shows another configuration example of the pixel circuit 501 according to one embodiment (first embodiment) of the invention.

FIG. 10 shows a pixel circuit 501 related to the pixel A. The same also applies to the pixel circuit related to the pixel B.

The pixel circuit 501 is provided with a scanning line 611, a data line 621, a data line 622, a TFT 701, a transistor 711, a capacitor 721, a TFT 801, a transistor 811, and a capacitor 821.

In the example of FIG. 10, the transistor 711 and the transistor 811 are N-MOS.

A scanning line 611 is connected to the gate of the TFT 701 and the gate of the TFT 801.

A data line 621 is connected to the source of the TFT 701. A data line 622 is connected to the source of the TFT 801.

The drain of the TFT 701, the gate of the transistor 711, and one end of the capacitor 721 are connected. The other end of the capacitor 721 is grounded.

The drain of the TFT 801, the gate of the transistor 811, and one end of the capacitor 821 are connected. The other end of the capacitor 821 is grounded.

Voltage #1 is applied to the source of the transistor 711. Voltage #2 is applied to the source of the transistor 811.

The drain of the transistor 711, the drain of the transistor 811, and the pixel electrode of the pixel A (for example, the pixel electrode 121 in the example of FIG. 2) are connected.

Data A is input to the data line 621. Data A is one of binary values (for example, low level and high level). A value obtained by inverting the high level and the low level of the data A is input to the data line 622.

In the pixel circuit 501 in the example of FIG. 10, the voltage #1 is applied to the pixel electrode of the pixel A when the data A is at a high level (for example, 1), and voltage #2 is applied to the pixel electrode of pixel A when the data A is at a low level (for example, 0).

Here, as another configuration example, a P-MOS may be used as the transistor 711 and the transistor 811, and the voltage #1 and the voltage #2 may be arranged in reverse. Explanation of Comparative Technique

Here, an example of a comparative technique for the display portion 11 of the electrophoretic display device 1 according to the present embodiment will be shown.

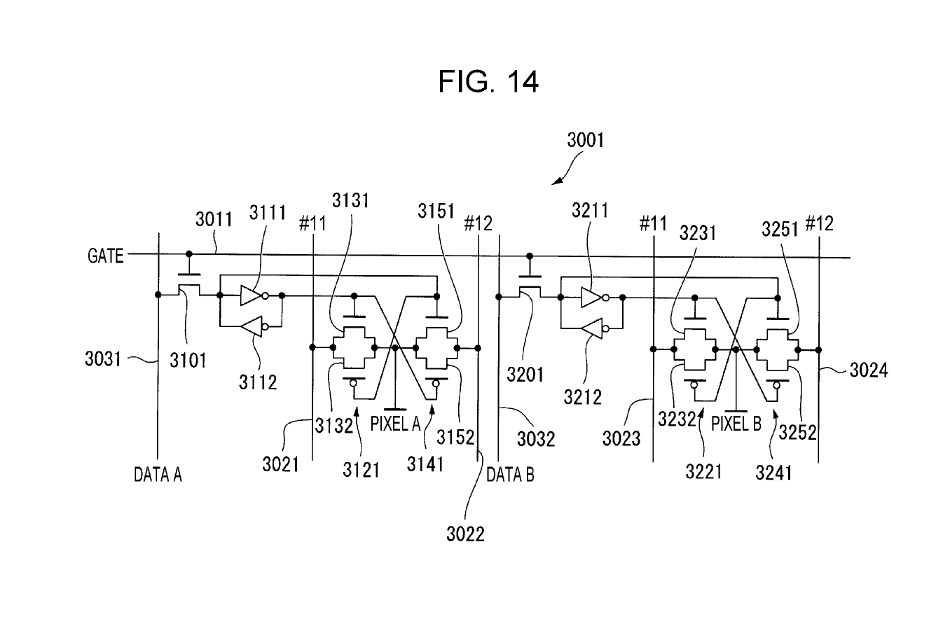

FIG. 14 is a diagram which shows a configuration example of the pixel circuit 3001 according to the comparative technique.

The pixel circuit 3001 is provided with a scanning line 3011 as a circuit common to the pixels A and B.

As circuits relating to pixel A, a control line 3021, a control line 3022, a data line 3031, a selection switch TFT 3101, an inverter 3111, an inverter 3112, a transfer gate 3121, and a transfer gate 3141 are provided. The transfer gate 3121 is provided with an N-MOS 3131 and a P-MOS 3132. The transfer gate 3141 is provided with an N-MOS 3151 and a P-MOS 3152. The circuit portions of the two inverters 3111 to 3112 are used as memories.

As circuits relating to pixel B, a control line 3023, a control line 3024, a data line 3032, a selection switch TFT 3201, an inverter 3211, an inverter 3212, a transfer gate 3221, and a transfer gate 3241 are provided. The transfer gate 3221 is provided with an N-MOS 3231 and a P-MOS 3232. The transfer gate 3241 is provided with an N-MOS 3251 and a P-MOS 3252. The circuit portions of the two inverters 3211 to 3212 are used as memories.

Here, in the pixel circuit 3001 in the example of FIG. 14, as compared with the pixel circuit 201 shown in FIG. 3, the point that the common voltage #11 is applied to the control line 3021 in the circuit related to the pixel A and the control line 3023 in the circuit related to the pixel B and the point that the common voltage #12 is applied to the control line 3022 in the circuit related to the pixel A and the control line 3024 in the circuit related to the pixel B are different.

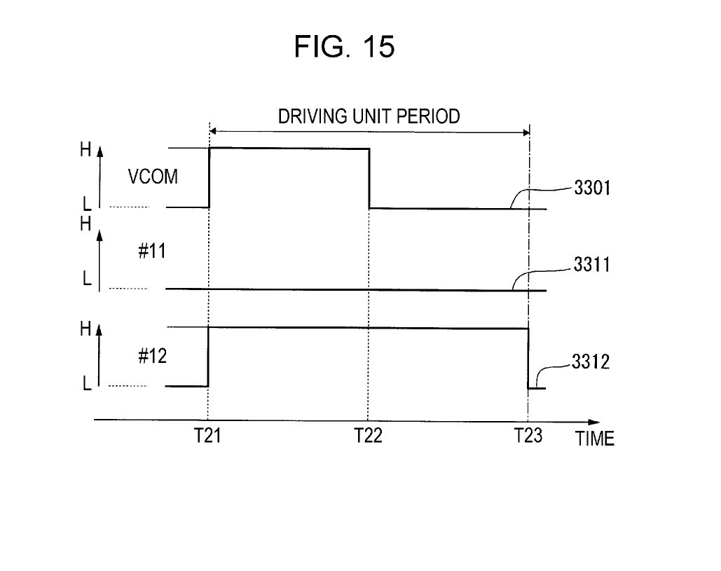

FIG. 15 is a diagram which shows an example of voltages applied to the pixel electrode and the counter electrode according to the comparative technique.

In the example of FIG. 15, voltages applied when pixels A and B are displayed with the same color (in the present example, white or black) are common.

FIG. 15 shows an example of voltage waveform changes over time for the voltage 3301 applied to the counter electrode (VCOM), the voltage 3311 (=voltage #11) applied to the pixel electrode at the time of black display, and the voltage 3312 (=voltage #12) applied to the pixel electrode at the time of white display.

In the graph shown in FIG. 15, the horizontal axis represents time and the vertical axis represents the voltage magnitude (high and low) for each voltage 3301, and 3311 to 3312.

Here, in the example of FIG. 15, the time T21 to the time T23 represent times proceeding in order. The time T23 is a later time than the time T21.

The voltage 3301 applied to the counter electrode is high level from the time T21 to the time T22 in the driving unit period and is low level from the time T22 to the time T23. The waveform of the voltage 3301 is a rectangular wave having a duty of 50%.

The voltage 3311 applied to the pixel electrode at the time of black display is always at the low level in the driving unit period.

The voltage 3312 applied to the pixel electrode at the time of white display is always high level in the driving unit period.

Note that the time T21, the time T22, and the time T23 in the example of FIG. 15 correspond to the time T1, the time T4, and the time T7 in the example of FIG. 4 respectively.

Here, description will be given of when the states of the memories of two adjacent pixels A and B (states of data A and B) are both low level.

At this time, both of the two pixels A and B display black, and the voltage 3311 is applied to the pixel electrode of the pixel A and the pixel electrode of the pixel B. In this case, from the time T21 to the time T22, with the voltage of the counter electrode as the reference voltage, the voltages of the pixel electrode of the pixel A and the pixel electrode of the pixel B become negative voltages. Then, the electric field generated between the pixel electrodes of the two adjacent pixels A and B and the counter electrode becomes uniform, and the movement of the particles is slow (compared with the case of the example of FIG. 4). In addition, in such a case, from the time T22 to the time T23, with the voltage of the counter electrode as the reference voltage, the voltages of the pixel electrode of the pixel A and the pixel electrode of the pixel B become equal to the reference voltage. Then, the electric field between the pixel electrodes and the counter electrodes of the two adjacent pixels A and B disappears, and the particle movement stops.

In addition, description will be given of when the states of the memories of two adjacent pixels A and B (states of data A and B) are both high level.

At this time, both of the two pixels A and B display white, and the voltage 3312 is applied to the pixel electrode of the pixel A and the pixel electrode of the pixel B. In such a case, from the time T21 to the time T22, with the voltage of the counter electrode as the reference voltage, the voltages of the pixel electrode of the pixel A and the pixel electrode of the pixel B become equal to the reference voltage. Then, the electric field between the pixel electrodes and the counter electrodes of the two adjacent pixels A and B disappears, and the particle movement stops. In addition, in such a case, from the time T22 to the time T23, with the voltage of the counter electrode as the reference voltage, the voltages of the pixel electrode of the pixel A and the pixel electrode of the pixel B become positive voltages. Then, the electric field generated between the pixel electrodes of the two adjacent pixels A and B and the counter electrode becomes uniform, and the movement of the particles is slow (compared with the case of the example of FIG. 4).

In the display portion 11 of the electrophoretic display device 1 according to the present embodiment, it is possible to solve the problems generated in the display portion of the electrophoretic display device according to the comparative technique described above.

### Summary of First Embodiment

As described above, in the electrophoretic display device 1 according to the present embodiment, when switching the display contents (display color) in the display portion 11, there is provided a period in which the voltages (the potential with respect to the counter electrode 131) applied to each pixel electrode (for example, pixel electrode 121 and pixel electrode 122) of two adjacent pixels (the pixel A and the pixel B) are different. Due to this, in the display portion 11, generating a period in which an uneven electric field is generated for two adjacent pixels makes it possible to promptly eliminate the antagonistic state of the movement of the charged particles (the white particles 152 and the black particles 153) and to accelerate the movement of the particles by generating a smooth flow of the charged particles and dispersion medium 151.

As a specific example, in the electrophoretic display device 1 according to the present embodiment, the display portion 11 has the following configuration.

That is, in a circuit which connects one of two control lines (two different voltages) to a pixel electrode according to the state (data value) of the memory of each pixel, one of two adjacent pixels A and B uses the first control line (the control line 221 in the example of FIG. 3) and the second control line (the control line 222 in the example of FIG. 3), while the other uses the third control line (the control line 223 in the example of FIG. 3) and the fourth control line (the control line 224 in the example of FIG. 3). Then, at the time of switching the display, the control portion 12 is provided with at least one period of a period in which the voltages applied to the pixel electrode by the first control line and the third control line (the potential with respect to the counter electrode 131) are different from each other and a period in which the voltages applied to the pixel electrode by the second control line and the fourth control line (potential with respect to the counter electrode 131) are different from each other.

As described above, in the electrophoretic display device 1 according to the present embodiment, it is possible to smoothly change the display color on the display portion 11.

For example, in the display portion 11, even when the state (the value of the data for determining color) of the memory of two adjacent pixels is the same, a period in which potentials (potentials with respect to the counter electrode 131) between the pixel electrodes of these two pixels are different is generated. Due to this, in the display portion 11, it is possible to smoothen the flow of the particles, for example, to make the display switching respond quickly.

In addition, in the present embodiment, the electrophoretic display device 1 where the control portion 12 controls the voltage applied to the pixel electrodes of each pixel of the display portion 11 is shown; however, the invention is not limited thereto. For example, a control device provided with the function of the control portion 12 may be implemented, or a driving method for executing a method similar to the method in which the control portion 12 drives the display portion 11 may be implemented.

### Second Embodiment

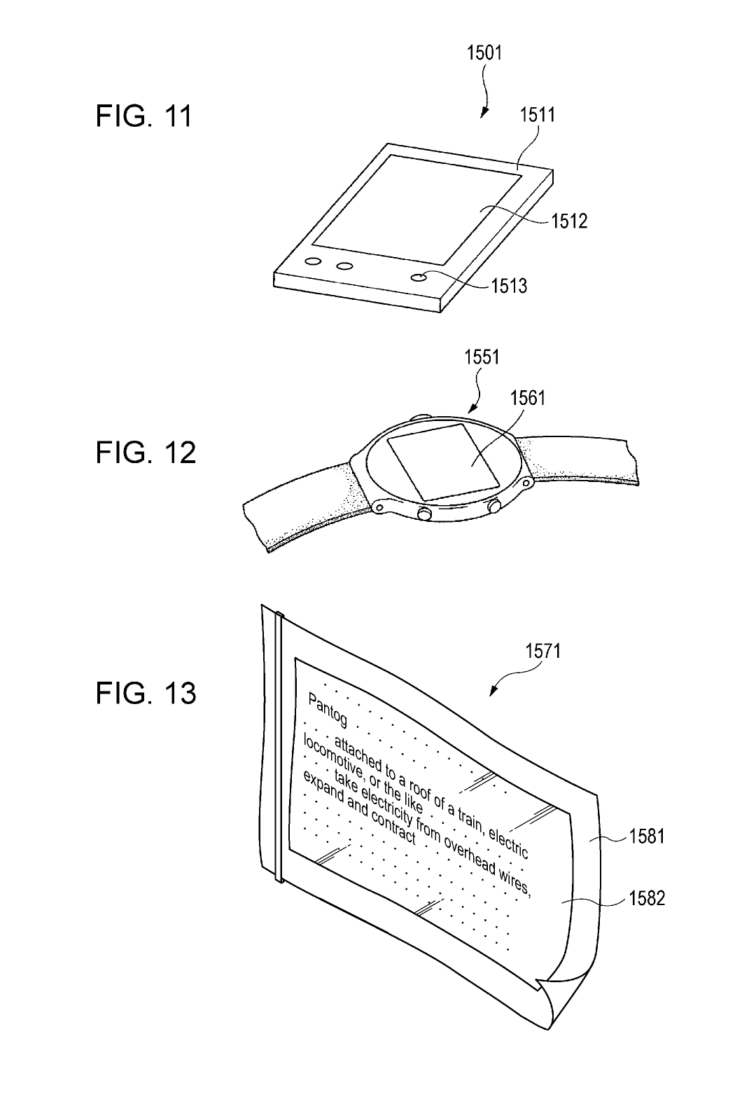

Description will be given of a schematic configuration example of an electronic apparatus according to an embodiment of the invention with reference to FIG. 11 to FIG. 13. In the present embodiment, a specific example of an electronic apparatus to which the electrophoretic display device (the electrophoretic display device 1 according to the first embodiment) according to the above embodiment is applied is shown.

FIG. 11 is a diagram which shows a schematic configuration example of an electronic apparatus according to one embodiment of the invention (a first example of a second embodiment).

Specifically, FIG. 11 is a perspective diagram which shows an electronic book 1501 which is an example of an electronic apparatus.

The electronic book 1501 is provided with a book-shaped frame 1511, a display portion 1512 to which the electrophoretic display device 1 according to the above-described embodiment is applied, and an operation portion 1513.

FIG. 12 is a diagram which shows a schematic configuration example of an electronic apparatus according to one embodiment (a second example of the second embodiment) of the invention.

Specifically, FIG. 12 is a perspective diagram which shows a wristwatch 1551 which is an example of an electronic apparatus.

The wristwatch 1551 is provided with a display portion 1561 to which the electrophoretic display device 1 according to the above embodiment is applied.

FIG. 13 is a diagram which shows a schematic configuration example of an electronic apparatus according to one embodiment (a third example of the second embodiment) of the invention.

Specifically, FIG. 13 is a perspective diagram which shows an electronic paper 1571 which is an example of an electronic apparatus.

The electronic paper 1571 is provided with a main body portion 1581 formed of a rewritable sheet having the same texture and flexibility as that of paper, and a display portion 1582 to which the electrophoretic display device 1 according to the above embodiment is applied.

Here, the electrophoretic display device 1 according to the above embodiment may be applied to various other electronic apparatuses and examples thereof include a display portion of an electronic apparatus such as a mobile phone or a portable audio device, industrial documents such as manuals, textbooks, problem workbooks, information sheets, and the like.

As described above, in the electronic apparatus according to the present embodiment, it is possible to obtain the same effects as those of the electrophoretic display device 1 according to the above embodiment.

### SUMMARY OF THE EMBODIMENTS

As one configuration example, there is an electrophoretic display device (the electrophoretic display device 1 in the embodiment) including a first substrate (the pixel substrate 101 in the example of FIG. 2) and a second substrate (the counter substrate 102 in the example of FIG. 2) which oppose each other, a first electrode (the pixel electrodes 121 to 123 in the example of FIG. 2) provided on the first substrate, a second electrode (the counter electrodes 131 in the example of FIG. 2) provided on the second substrate, a region forming portion (in the example of FIG. 2, the partition walls 111 to 112, and microcapsules in another example) for forming a plurality of regions (cells) between the first substrate and the second substrate, a dispersion liquid (in the example of FIG. 2, the dispersion liquid 141) which includes particles (in the example of FIG. 2, the white particles 152 and the black particles 153) and a dispersion medium (in the example of FIG. 2, the dispersion medium 151) provided between the first electrode and the second electrode, and a control portion (in the example of FIG. 1, the control portion 12) which applies a voltage to the first electrode, in which the first electrode is provided for each pixel, and when the control portion makes an adjacent first pixel (pixel A in the embodiment) and second pixel (pixel B in the embodiment) display the same color, the control portion applies voltages having different waveforms to the first electrode of the first pixel and the first electrode of the second pixel (example of FIG. 4 and example of FIG. 9).

As one configuration example, in the electrophoretic display device, in a case where the same color is displayed in an adjacent first pixel and second pixel, the control portion applies voltages having a potential difference to the first electrode of the first pixel and the first electrode of the second pixel at the start of display switching (example of FIG. 4 and example of FIG. 9).

As one configuration example, in the electrophoretic display device, in a case where at least one adjacent second pixel is made to display the same color as the first pixel in a plurality of the pixels arranged in a matrix shape, the control portion applies voltages having different waveforms to the first electrode of the first pixel and the first electrode of the second pixel (examples of FIG. 5 to FIG. 8).

As one configuration example, in the electrophoretic display device, the first pixel is provided with a first electrode of the first pixel, a first storage circuit (the inverters 311 and 312 in the example of FIG. 3), a pair of first switching circuits (a pair of transfer gates 321 and 341 in the example of FIG. 3) one of which conducts while the other interrupts according to a state of the first storage circuit, in which one terminal of the pair of the first switching circuits is connected in common to the first electrode of the first pixel and each other terminal is connected to each of a first control line (the first control line 221 in the example of FIG. 3) and a second control line (the second control line 222 in the example of FIG. 3), the second pixel is provided with the first electrode of the second pixel, a second storage circuit (the inverters 411 and 412 in the example of FIG. 3), and a pair of second switching circuits (a pair of transfer gates 421 and 441 in the example of FIG. 3) one of which conducts while the other interrupts according to a state of the second storage circuit, in which one terminal of the pair of the second switching circuits is connected in common to the first electrode of the second pixel and each other terminal is connected to each of a third control line (the third control line 223 in the example of FIG. 3) and a fourth control line (the fourth control line 224 in the example of FIG. 3).

As one configuration example, in the electrophoretic display device, one of the first control line and the second control line and one of the third control line and the fourth control line are in common (configuration example corresponding to the example of FIG. 9). Note that, the one of the first control line and the second control line may be either one, and the one of the third control line and the fourth control line may be either one.

As a configuration example, there is an electronic apparatus which is provided with the electrophoretic display device as described above (for example, the examples of FIG. 11 to FIG. 13).

As one configuration example, there is provided a control device (for example, an apparatus having a function similar to the function of the control portion 12) which controls an electrophoretic display device provided with a first substrate and a second substrate which oppose each other, a first electrode provided on the first substrate, a second electrode provided on the second substrate, a region forming portion for forming a plurality of regions between the first substrate and the second substrate, and a dispersion liquid which includes particles and a dispersion medium provided between the first electrode and the second electrode, the first electrode being provided for each pixel, in which, when making an adjacent first pixel and second pixel display the same color, voltages having different waveforms are applied to the first electrode of the first pixel and the first electrode of the second pixel.

As one configuration example, there is provided a driving method (for example, a driving method similar to the driving method performed by the control portion 12) for driving an electrophoretic display device provided with a first substrate and a second substrate which oppose each other, a first electrode provided on the first substrate, a second electrode provided on the second substrate, a region forming portion for forming a plurality of regions between the first substrate and the second substrate, and a dispersion liquid which includes particles and a dispersion medium provided between the first electrode and the second electrode, the first electrode being provided for each pixel, in which, when making an adjacent first pixel and second pixel display the same color, voltages having different waveforms are applied to the first electrode of the first pixel and the first electrode of the second pixel.

Note that, a program for realizing the function of any component in the apparatus or the like described above (for example, the control portion 12, the control device, or the electronic apparatus) may be recorded (stored) in a computer-readable recording medium (storage medium), and the program may be read and executed by the computer system. Note that, the “computer system” referred to here includes hardware such as an operating system (OS) or peripheral equipment. In addition, the “computer-readable recording medium” refers to a portable medium such as a flexible disk, a magneto-optical disc, a Read Only Memory (ROM), or a Compact Disk (CD)-ROM, or a storage apparatus such as a hard disk built in the computer system. Furthermore, the “computer readable recording medium” includes media holding programs for a certain period of time such as a volatile memory (RAM: Random Access Memory) inside a computer system serving as a server or a client in a case where a program is transmitted via a network such as the Internet or a communication line such as a telephone line.

In addition, the program described above may be transmitted from a computer system in which the program is stored in a storage apparatus or the like to another computer system via a transmission medium or by a transmission wave in a transmission medium. Here, the “transmission medium” for transmitting the program refers to a medium having a function of transmitting information such as a network (communication network) such as the Internet or a communication line (communication line) such as a telephone line.

In addition, the program described above may be for realizing some of the functions described above. Furthermore, the program described above may be a so-called difference file (differential program) which is able to realize the functions described above in combination with a program already recorded in the computer system.

Detailed description was given above of the embodiment of the invention with reference to the drawings; however, the specific configuration is not limited to this embodiment, and includes designs and the like within a range not departing from the gist of the invention.

The entire disclosure of Japanese Patent Application No. 2016-076398, filed Apr. 6, 2016 is expressly incorporated by reference herein.

What is claimed is:

1. An electrophoretic display device comprising:
a first substrate and a second substrate which oppose each other;
a first electrode provided on the first substrate;
a second electrode provided on the second substrate;
a region forming portion for forming a plurality of regions between the first substrate and the second substrate;
a dispersion liquid which includes particles and a dispersion medium provided between the first electrode and the second electrode; and
a control portion which applies a voltage to the first electrode,
wherein the first electrode is provided in a pixel, and
when the control portion makes adjacent first and second pixels display the same color, the control portion applies voltages having different waveforms to the first electrode of the first pixel and the first electrode of the second pixel.

2. The electrophoretic display device according to claim 1,
wherein, when the control portion makes the adjacent first pixel and second pixel display the same color, the control portion applies voltages having a potential difference at a start of display switching to the first electrode of the first pixel and the first electrode of the second pixel.

3. The electrophoretic display device according to claim 1,
wherein, when the control portion makes at least one adjacent second pixel display the same color as the first pixel in a plurality of the pixels arranged in a matrix shape, the control portion applies voltages having different waveforms to the first electrode of the first pixel and the first electrode of the second pixel.

4. The electrophoretic display device according to claim 1,
wherein the first pixel is provided with the first electrode of the first pixel, a first storage circuit, and a pair of first switching circuits one of which conducts while the other interrupts according to a state of the first storage circuit,
one terminal of the pair of first switching circuits is connected in common to the first electrode of the first pixel and another terminal is connected to a first control line and a second control line,
the second pixel is provided with the first electrode of the second pixel, a second storage circuit, and a pair of second switching circuits one of which conducts while the other interrupts according to a state of the second storage circuit,
one terminal of the pair of second switching circuits is connected in common to the first electrode of the second pixel and another terminal is connected to a third control line and a fourth control line.

5. The electrophoretic display device according to claim 4,
wherein one of the first control line and the second control line and one of the third control line and the fourth control line are in common.

6. An electronic apparatus comprising:
the electrophoretic display device according to claim 1.

7. An electronic apparatus comprising:
the electrophoretic display device according to claim 2.

8. An electronic apparatus comprising:
the electrophoretic display device according to claim 3.

9. An electronic apparatus comprising:
the electrophoretic display device according to claim 4.

10. An electronic apparatus comprising:
the electrophoretic display device according to claim 5.

11. A control device which controls an electrophoretic display device including
a first substrate and a second substrate which oppose each other;
a first electrode provided on the first substrate;
a second electrode provided on the second substrate;
a region forming portion for forming a plurality of regions between the first substrate and the second substrate; and
a dispersion liquid which includes particles and a dispersion medium provided between the first electrode and the second electrode,
wherein the first electrode is provided in a pixel,
when making adjacent first and second pixels display the same color, voltages having different waveforms are applied to the first electrode of the first pixel and the first electrode of the second pixel.

12. A driving method for driving an electrophoretic display device including
a first substrate and a second substrate which oppose each other;
a first electrode provided on the first substrate;
a second electrode provided on the second substrate;
a region forming portion for forming a plurality of regions between the first substrate and the second substrate; and
a dispersion liquid which includes particles and a dispersion medium provided between the first electrode and the second electrode,
wherein the first electrode is provided in a pixel,
when making adjacent first and second pixels display the same color, voltages having different waveforms are applied to the first electrode of the first pixel and the first electrode of the second pixel.

13. An electronic apparatus comprising:
the control device according to claim 11.
